(19) United States
(12) Patent Application Publication
(10) Pub. No.: US 2026/0318332 A1
(43) Pub. Date: Oct. 15, 2026

(54) PROGRAMMABLE ULTRASOFT LOGIC AND ROUTING PLATFORM VIA DROPLET-CREASE INTERACTIONS

(71) Applicants: Anupam Pandey, Fayetteville, NY (US); Zixuan Wu, Syracuse, NY (US); Gavin Chance Linton, Homer, NY (US)

(72) Inventors: Anupam Pandey, Fayetteville, NY (US); Zixuan Wu, Syracuse, NY (US); Gavin Chance Linton, Homer, NY (US)

(73) Assignee: Syracuse University, Syracuse, NY (US)

(21) Appl. No.: 19/463,384

(22) Filed: Jan. 29, 2026

Related U.S. Application Data
(60) Provisional application No. 63/751,008, filed on Jan. 29, 2025.

(51) Int. Cl. F15C 3/00

(52) U.S. Cl. CPC F15C 3/002

(57) ABSTRACT

A logic platform includes a bilayer structure of polymeric materials, where a softer, top polymer layer is attached to a patterned base layer of a much stiffer polymer. At least one crease is produced at the surface of the soft polymer under compressive forces. A geometric pattern formed on the base layer determines the location of the crease on the soft top surface of the substrate. Liquid droplets are introduced on the creased surface and the interactions of the droplets with the crease produce active and passive gating. The gating may include logic operations, selective transport, filtering, or routing of the droplets. The substrate enables selective inducement and release of the creases, thereby enabling the platform to be controllable, as well as reversible. The described platform operates without irreversible surface modification and enables reconfigurable droplet manipulation through elastocapillary interactions.

### CROSS-REFERENCE TO RELATED APPLICATION

This application claims priority to U.S. Provisional Patent Application Ser. No. 63/751,008, filed Jan. 29, 2025, the entirety of which is incorporated by reference herein for all purposes.

### BACKGROUND

Computations and information processing have been a center of focus within various scientific communities in recent years due to the rapid expansion of artificial intelligence (AI) and data-driven technologies. Progress in machine learning has also brought about a resurgence of interests in fields such as analog computing, physical intelligence, and mechanical computing due to the inherent energy efficiency of information manipulation without a CPU. These alternative computing paradigms seek to encode and process information directly through physical states and interactions, rather than relying exclusively on conventional digital electronic architectures. At the core of computing, information is inherently physical, as current transistors in digital computations rely on semiconductor switches as logic gates. Physical computation platforms, which conduct both information processing and matter manipulation, operate on physical bits by carrying material payloads, as shown in various known physical logic systems in the past. Such physical logic systems have been demonstrated using fluidic, mechanical, and soft-matter platforms, where information is represented by the position, configuration, or motion of material entities.

During the early-stage development of computing, fluidics served as a possible alternative for solid-state electronics. Developments in microfluidics have re-sparked development of new logic families with droplets acting as physical bits. In such systems, droplets encode information through their size, position, or motion, enabling computation through controlled transport and interaction. Besides carrying information, directed and selective transport or manipulation of micro to nano-liter droplets attracted intensive research interests due to its necessity in condensations, self-assembly, microfabrication, and automation of healthcare diagnostics and various analytical chemistry tasks. Droplets are commonly programmed by modifying the wetting properties of the underlying substrate, with significant chemical, electrical or topographical alterations that either: 1) demand advanced and potentially costly substrate fabrication, and/or 2) often involve irreversible surface modifications. Such approaches can limit reconfigurability, in situ tunability, and dynamic adaptation of droplet-based logic or transport platforms.

Recently, ultrasoft, polymeric substrates with stiffness down to a few hundred Pascals showed the potential of controlling droplet motion upon them, and without the need of externally applied electrical or magnetic fields. On these substrates, droplets were shown to exhibit long range interaction, leading to pattern formation and self-assembly analogous to durotaxis observed in cells. These interactions arise from elastocapillary coupling between the droplet and the deformable substrate,

### BRIEF DESCRIPTION

As described herein, Applicant has devised a technique for manipulating droplets on ultrasoft substrates by leveraging creases, which nucleate on a soft surface of the substrate under applied compressive stresses. The creases may be formed at predetermined locations and geometries through patterning of the substrate. The repulsive interaction between a liquid droplet and an induced crease, which is elastocapillary in origin, is the primary motif of this logic platform. The repulsive interaction refers to an effective elastocapillary energy barrier arising from substrate deformation. Since creases are elastic features that can be introduced and erased reversibly, the afore noted platform is reprogrammable with passive and active gating capabilities. The gating behavior may further depend on one or more droplet properties, including size, surface tension, or composition.

According to at least one aspect of the present invention, there is provided a programmable and reversible elastocapillary logic platform with localized patterning of creases, in which the patterned creases create non-linear repulsion with droplets that is sufficiently strong to function as logic gates, in which a variable gating based on droplet volume or surface tension can be achieved as a non-electrically based analog of adaptive-gate transistors. The gating may further enable selective transport, filtering, or routing of droplets in addition to logic operations. The gating is simultaneously passive, with a naturally embedded gating, and active, meaning the logic platform is selectively tunable or even reversible via crease relaxation. To our knowledge, such interfacial, elastocapillary-based logic that is reversible, tunable, and programmable, along with various gating options is the first in the three-phase logic family. A logic operation is reversible if it is a bijective (one-to-one and onto) mapping between input states and output states. Such reversibility may be achieved through reversible mechanical modulation of the creases. In computing, logic-operative hardware is considered tunable when its functional behavior or operating characteristics can be adjusted in situ by modifying one or more physical or electrical control parameters, without replacing components.

The herein described logic platform and gating concepts can be demonstrated with table-top manufacturing, low-cost materials without requiring advanced surface chemistry and topographical fabrications or additional flow/electrical controls, in which physical phenomena can be used to implement passive but rigorous logic gating with “free” gravitation potentials. Such gating may alternatively be driven by other mechanical or energetic biases. Minimal surface modifications also imply the potential for integration with programmable biofilm growth where automated delivery of nutrients, toxins, and various chemical reagents to designated regions can be achieved with prescribed spatio-temporal path planning.

According to an embodiment, the platform can include a bilayer substrate defined by a stiff base layer and a softer top layer. In at least one version, the soft layer is inset within a defined cavity formed in the base layer. The cavity may have any suitable geometry and is not limited to a particular shape or depth. The cavity can further include a patterned bottom surface. The application of compressive forces against the base layer of the substrate can induce the formation of one or more creases in the soft layer. Liquid droplets can be caused to move along the substrate in which interactions are produced between the induced creases and the liquid droplets.

According to at least one version, the gating that is produced by the platform is both active and passive. In one or more versions, the active and passive gating can be achieved simultaneously, wherein the gating is made controllable based on droplet sizes in relation to the one or more induced creases. The gating may additionally or alternatively depend on one or more droplet properties, including surface tension, or composition. The active and passive gating modes may be implemented independently, sequentially, or concurrently.

According to another aspect, there is provided a method for fluidically gating, the method comprising the steps of providing a base layer of a bilayer substrate, the base layer being made from a polymer material of a first stiffness; providing a top layer made from a polymer material of a second stiffness that is considerably less than the first stiffness; inducing a crease in the top layer of the substrate, and manipulating one or more droplets based on interaction between the induced crease and liquid droplet(s) added to the substrate.

In at least one version, the method can further comprise the additional steps of forming a cavity in an upper surface of the base layer; the cavity having a geometry selected to localize crease formation, placing the base layer into tension by laterally stretching the base layer; disposing the top layer into the formed cavity of the base layer; and releasing the stretching of the base layer, thereby placing the top layer in compression and inducing formation of a said crease in the top layer. The described steps represent one non-limiting method for inducing compressive strain and crease formation in the top layer.

These and other features and advantages will be readily apparent from the following Detailed Description, which should be read in conjunction with the accompanying figures.

### BRIEF DESCRIPTION OF THE DRAWINGS

FIG. 1A is a diagrammatic view taken both as a side elevational view in section and a top plan view of an experimental setup of a logic platform made in accordance with aspects of the present teachings;

FIG. 1B depicts a time-phase image sequence demonstrating active and passive gating of liquid droplets relative on crease interactions for a logic platform such as that presented in FIG. 1A, in which the interactions are based, at least in part, on liquid droplet sizes;

FIG. 1C schematically depicts gating and halting/stopping distances of droplets due to repulsive interaction of the liquid droplets with a crease such as induced via the experimental setup of FIGS. 1A and 1B;

FIG. 1D. depicts droplet stopping/halting distances of liquid droplets relative to an induced crease as a function of droplet radii; and

FIG. 1E depicts a distance/time plot of various liquid droplet trajectories in relation to an induced crease for various droplet sizes.

### DETAILED DESCRIPTION

The following describes various aspects of a programmable and reversible logic platform that is fluidically based upon a bilayer substrate made up of a soft upper layer that is disposed upon or within a stiffer base layer in which crease interaction with liquid droplets creates controllable (programmable) gating effects. The gating effects may include logic operations, selective transport, filtering, or routing of liquid droplets. It will be readily apparent that the description that follows relates to examples based on a defined experimental setup/platform, wherein the defined platform is entirely scalable and programmable. As such, modifications and variations will also be readily apparent that embody the inventive concepts. The described embodiments are intended to be illustrative and non-limiting.

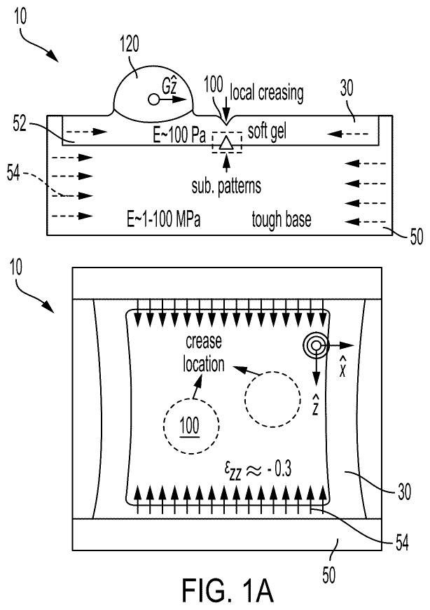

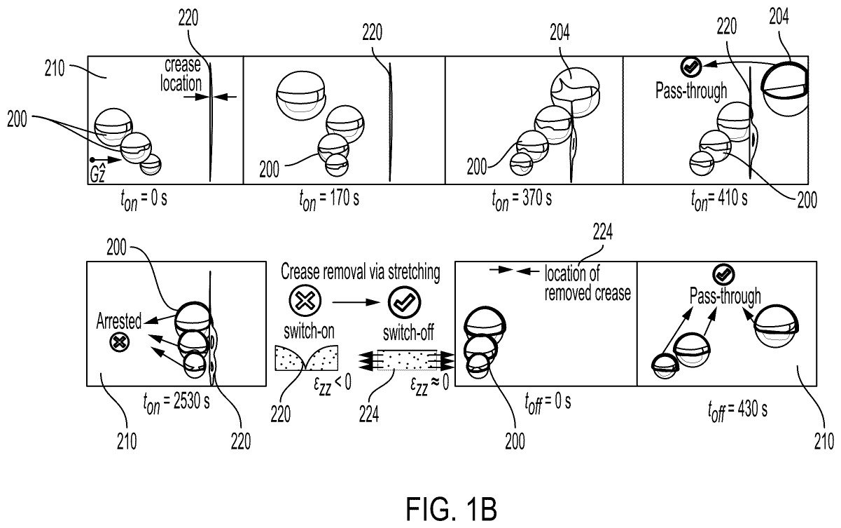

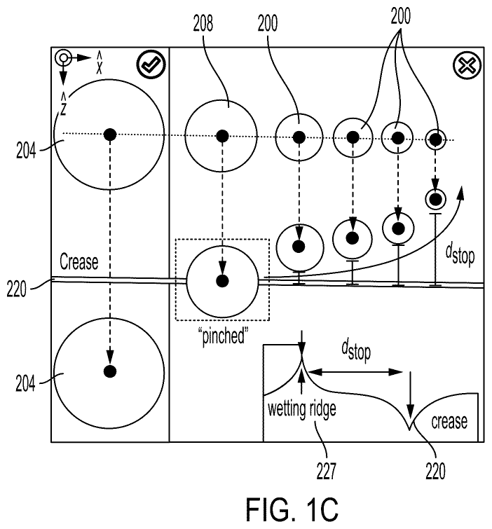

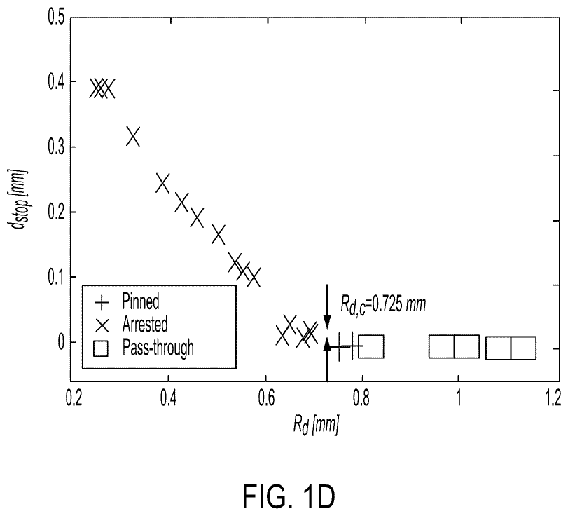

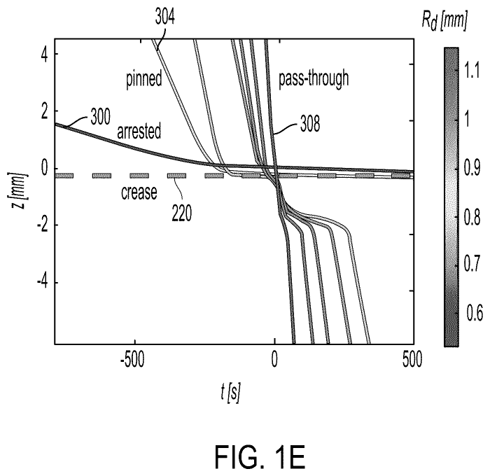

With reference to FIG. 1A, a polymer bilayer system 10 is shown in accordance with an exemplary embodiment, the system 10 being made up of a soft top layer 30 covering a base layer 50. The respective elastic modulus of the soft top and base layers 30 and 50 are significantly different with the soft top layer 30, upon which creases are formed, having an elastic modulus that is much softer than that of the stiffer base layer 50. According to at least one version, the base layer 50 in FIG. 1A can be fabricated by curing the mixture of two components (1:1 by weight) of a relatively stiff polymer. According to this specific setup, silicone polymer Zhermack Elite Double 8 and 22 is used as the base layer 50. This material selection is provided as one non-limiting example. Other polymeric or elastomeric materials of comparable stiffness may also be used. The base layer 50 is further designed, according to this specific embodiment, to have a defined cavity or well 52 formed in an upper surface, in which the bottom surface of the cavity 52 is defined by ridge, notch or similar pattern. The pattern serves to localize the nucleation of creases in the soft top layer. According to this embodiment, the defined cavity 52 is approximately 3 mm in depth with a 0.6 mm ridge or notch pattern. For purposes of fabrication and with the help of linear stages or similar means, the base layer 50 can be stretched. Alternative methods of applying tensile or compressive strain may also be employed. Once the stiff base layer 50 has been stretched, the soft top polymer layer 30 can be deposited into the formed cavity or well 52. As noted, the soft top layer 30 is made from a polymer material that is considerably softer than that of the base layer 50. According to this specific embodiment, a typical material choice for a soft polymer is Dowsil CY 52-276, with components A and B mixed at ratio of 1:1 to 1:3 by weight. This material system is provided as an illustrative example and is not intended to be limiting. It will be understood that other suitable materials having disparate stiffnesses can be utilized for the top and base layers 30, 50.

Once the soft top layer 30 is cured, the induced stretch of the base layer 50 can be released, thereby creating a compressive strain of up to 30-40% on the top layer 30 that is disposed in the formed well 52. This compressive strain is denoted by ϵ_{zz}. Creases nucleate on the top surface, just above the notch-like pattern 100 on the base layer 50, as ϵ_{zz} reaches up to 30-40 % (0.3-0.4) as shown by arrows 54. This compression is induced onto the topmost surface of the soft polymer layer 30, directly above the ridge/notch pattern formed in the cavity 52, herein representing a crease structure 100. More specifically, the ridge/notch pattern formed on the bottom surface of the cavity 52 acts to localize the crease nucleation on the surface of the soft polymer layer 30. One or more liquid droplets 120 are deposited onto the creased surface. The herein described experimental setup is oriented as shown in FIG. 1A, with the direction of gravity G in the direction z^{\hat{ }}, being the main energy source for droplets introduced to the herein defined system 10.

Basic passive gating capacity can first be demonstrated arising from drop-crease interactions. A horizontal line crease can be observed in FIG. 1B in which a series of liquid droplets 200 of varying size are caused to move over a substrate 210, such as that previously shown and described in FIG. 1A. The liquid droplets 200 are caused herein to move under the effect of gravity relative to a crease introduced to the soft layer of the system, which is shown pictorially in an example of a time phased sequence. Initially, the liquid droplets are depicted at time tₒₙ=0 seconds, where “on” denotes a switch-on state for the crease logic gate. The liquid droplets 200 are initiated for movements on the substrate 210 under gravitational pull, which is herein shown as G_{z}. At a later time tₒₙ=370−410 seconds, it is noted that smaller liquid droplets 200 are halted in front of the creases 220 while the largest droplet 204 has easily passed through the crease 220, which is denoted as a “1” in logic, as the three (3) smaller droplets 200 are halted indefinitely at time tₒₙ over 2500 seconds, denoting “0” in logic. Active gating control can be applied by erasing the creasing instability via stretching the polymer bilayer 50, FIG. 1, back to its original length such that the compressive strain ϵ_{zz} reaches, as seen in time t_{off}=0 s in which “off” denotes a switch-off state for the crease logic gate in which the droplets 200 and the previous crease locations, shown as 224, are shifted to the left as shown, and the previously halted droplets 200 begin to pass through, turning into logic signals of “1”. The logic state assignment is provided for illustrative purposes to describe gating behavior. Therefore, dual capacity of the drop-crease logic is demonstrated by 1) passive gating in a filter mode, as well as 2) active gating, in a switch mode.

Still referring to FIG. 1B and if close attention is directed to the halting or stopping distances of the smaller liquid droplets 200 at tₒₙs=2530 s, it can be seen that these smaller droplets are not arrested at fixed distances relative to the induced crease 220. This latter effect is clearly illustrated in the schematic depicted in FIG. 1C showing that smaller liquid droplets 200 halt further from the crease 220, and that liquid droplets 204 having a radius that is larger than a critical radius R_{d,c} pass through the crease 220. This critical radius R_{d,c} determines if a liquid droplet behaves logically either as a “1” (pass-through) or as a “0” (arrested). Liquid droplets 208 having a radius that is close to R_{d,c}, become pinned or pinched on the crease 220. These pinned droplets 220 (one being shown in FIG. 1C) are unable to slide further down under the effects of gravity and remain attached to the crease 220. The halting or stopping distance, dₛₜₒₚ for a liquid droplet arises from the repulsive interaction between the crease 220 and the wetting ridge 227 formed at the droplet contact line, as represented in the inset of FIG. 1C. The halting distance dₛₜₒₚ depends on various physical parameters of the system, such as the size of the liquid droplet, the various stiffnesses of soft and base layers of the substrate, and the size and shape of the crease.

The data corresponding to the schematic of FIG. 1C is presented in FIG. 1D; the arresting positions or the halting distances dₛₜₒₚ measured from the crease to the bottom most point (south pole) of the droplet is plotted as a function R_{d}. The data confirms that the smaller the size of the liquid droplet, the larger the droplet's stopping/halting distance becomes from the crease. This data also points to a clear threshold in droplet radius, for example, R_{d,c}=0.725 mm in this embodiment, above which the liquid droplets come in contact with the crease, either remaining pinned to the crease, or passing through the crease. The value of the critical radius may vary depending on substrate stiffness, crease geometry, and droplet properties.

Analysis of the motion of the droplets as they approach a crease(s) provide further insight into the interaction between an induced crease and the liquid droplet. FIG. 1D shows the position of a droplet's south pole (bottommost point) relative to the crease 220 as a function of time. Different colors represent different droplet sizes (R_{d}), with blue being the smallest droplet size and red being the largest droplet size. Three (3) different kind of trajectories are observed in this embodiment with reference to FIG. 1E. The first kind of trajectories 300 flatten out, reaching a positive z value, and represent those liquid droplets that are arrested by the crease 220 ahead of the moving droplet. The second kind of trajectories 304 reach z=0 and become flat and are representative of droplets that contact the crease 220 and remain pinned on the crease 220. The third class of trajectories 308 represent liquid droplets that are able to pass-through the crease 220. These latter droplet tracks exhibit deceleration as they cross the crease 220, but eventually recover a steady velocity. A crease thus can be understood as a surface defect for the liquid droplets, applying an energy barrier on the latter. Larger liquid droplets, due to their higher available driving energy, overcome this energy barrier. On the contrary, as the droplet size decreases, the more significant the crease becomes as a barrier, until the height of the crease is too high for the liquid droplet to cross.

While the invention has been described in terms of particular variations and illustrative figures, those of ordinary skill in the art will recognize that the invention is not limited to the variations or figures described. The described embodiments are provided for illustrative purposes only. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. Therefore, to the extent there are variations of the invention, which are within the spirit of the disclosure or equivalent to the inventions found in the claims, it is the intent that this patent will cover those variations as well. All such modifications and variations are intended to fall within the scope of the appended claims.

To the extent that the claims recite the phrase “at least one of” in reference to a plurality of elements, this is intended to mean at least one or more of the listed elements, and is not limited to at least one of each element. For example, “at least one of an element A, element B, and element C,” is intended to indicate element A alone, or element B alone, or element C alone, or any combination thereof. “At least one of element A, element B, and element C” is not intended to be limited to at least one of an element A, at least one of an element B, and at least one of an element C. This interpretation applies consistently to the claims, specification, and embodiments described herein.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated and in accordance with the following appended claims. Additional embodiments include any one of the embodiments described above and described in any and all exhibits and other materials submitted herewith, where one or more of its components, functionalities or structures is interchanged with, replaced by or augmented by one or more of the components, functionalities or structures of a different embodiment described above.

### PARTS LIST FOR FIG. 1A-1E

10 bilayer system
30 soft top layer
50 base layer
52 cavity or well
54 arrows
100 crease
200 liquid droplets
204 liquid droplet
208 pinched or pinned liquid droplet
210 substrate
220 crease
224 location of removed crease
227 wetting ridge
300 droplet trajectory
304 droplet trajectory
308 droplet trajectory

1. A logic platform having an ultrasoft polymer substrate compressed by an underlying layer of stiffer polymer developing localized surface creases, in which liquid droplets are introduced in relation to one or more creases, wherein the interactions of the liquid droplets with the one or more creases produce gating, wherein the gating includes logic operations, selective transport, filtering, or routing of the liquid droplets.

2. The logic platform according to claim 1, in which the produced gate is both active and passive.

3. The logic platform according to claim 1, wherein the gating is controllable based on droplet sizes in relation to the one or more creases, and/or one or more droplet properties including surface tension, or composition.

4. The logic platform according to claim 1, wherein active and passive gate is achieved may be achieved independently, sequentially, or simultaneously.

5. The logic platform according to claim 1, wherein the gating is dictated by pass-through or lack of pass-through of the droplets relative to the one of more creases to represent different gating states.

6. The logic platform according to claim 1, wherein a plurality of creases are arranged to provide sequential or networked gating of droplets.

7. The logic platform according to claim 1, wherein the ultrasoft polymer substrate comprises a base layer made from a first polymer material and a top layer made from a polymer material made from a second polymer material, in which the first polymer material is considerably stiffer than the second polymer material.

8. The logic platform according to claim 6, wherein the base layer includes a formed rectangular cavity in which the top layer is disposed, and in which one or more protrusions are formed on the bottom of the cavity.

9. The logic platform according to claim 7, wherein the base layer of the substrate is a single molded body made from the first polymer material.

10. The logic platform according to claim 7, wherein the base layer is subjected to tensile stress prior to seating of the top layer in the formed cavity.

11. The logic platform according to claim 7, wherein the one or more protrusions at the bottom or the cavity define a ridge structure having a notch or similar pattern.

12. The logic platform according to claim 9, in which the top layer is placed under a compressive stress when the tensile stress subjected to the base layer is released, thereby creating one or more creases in the top layer.

13. The logic platform according to claim 11, wherein the compressive stress is on the order of tens of percent.

14. A method for fluidically gating, the method comprising:
providing a base layer of a bilayer substrate, the base layer being made from a polymer material of a first stiffness;
providing a top layer made from a polymer material of a second stiffness that is considerably less than the first stiffness;
inducing a crease in the top layer of the substrate, and
manipulating one or more droplets based on interaction between the induced crease and liquid droplet(s) added to the substrate, wherein the droplets are driven by gravity or other imposed mechanical or energetic biases.

15. The method according to claim 13, further comprising:
forming a ridge in the well/cavity geometry of the base layer;
placing the base layer into tension by laterally stretching the base layer;
disposing the top layer into the formed cavity of the base layer; and
releasing the stretching of the base layer, thereby placing the top layer in compression and inducing formation of a said crease in the top layer.

16. The method according to claim 14, wherein the compressive stress acting on the top layer is on the order of tens of percent.

17. The method according to claim 14, further including adding a notch or similar pattern in a bottom surface of the formed cavity of the top layer.

18. The method according to claim 14, in which the manipulation of the droplets includes gating based on interactions between liquid droplets and the induced crease.

19. The method according to claim 17, in which the gating is active and passive.

20. The method according to claim 17, wherein the gating is controllable or programmable in which induced creases can be relieved by stretching the base layer of the substrate.

21. A logic platform comprising:
a bilayer substrate, having a stiff base layer and a soft top layer;
the soft top layer being inset within a defined cavity formed in the stiff base layer, further comprising at least one crease within the soft top layer, the stiff base layer imposing a compressive force on the soft top layer;
inducing the formation of the at least one crease in the soft layer; wherein liquid droplets can be caused to move along the substrate in which interactions are produced between the induced creases and the liquid droplets to produce gating, selective transport, filtering, or routing of the droplets.
